(19) United States
(12) Patent Application Publication
(10) Pub. No.: US 2008/0178781 A1
(43) Pub. Date: Jul. 31, 2008

(54) Anti-rubbery shielding system equipped with alert mechanisms

(76) Inventor: James Dalhe Kim, Riverside, CA (US)

Correspondence Address: Eugene OAK, 610 S. Van Ness Ave., Los Angeles, CA, 90005, US

(21) Appl. No.: 11/699,587

(22) Filed: Jan. 30, 2007

(51) Int. Cl. E06B 9/02; G08B 13/02

(52) U.S. Cl. 109/11; 109/21; 109/12

(57) ABSTRACT

An anti-rubbery shielding system having at least one vertically popping-up panels is provided. The popping-up panel is suitably comprised of a light, transparent, and rigid plastic that is bullet-resistant. Purpose of the anti-rubbery shielding system according to current application is to protect a clerk in a convenience store, liquor shop, and other small stores which open until late night and to drive out a rubber by scaring. The anti-rubbery shielding system is provided with alert mechanisms of police car siren, voice message of a policeman, visual effect, video record that are operatively associated with the one or more vertically popping-up panels. The anti-rubbery shielding system is activated when the clerk press a button on the floor beneath the cashier's desk by foot.

### FIELD OF THE INVENTION

Current application relates to an anti-rubbery shielding system, particularly for a cashier's desk in a gas station, a convenience store, liquor shop, and other small stores which open until late night and to drive out a rubber by scaring. More particularly, the present invention relates to a novel security shielding system that has one or more vertically pop-up panels, and an alerting system.

### BACKGROUND OF THE INVENTION

There are many devices in the prior art for moving a door or window panel. In general, the prior devices relating to security cages for bank clerks have one moving panel that closes “instantaneously”, i.e., extremely quickly in about 0.5 second or less. The panel typically is an opaque steel shield. However, the need has been increasing for a security enclosure for night shift clerks in a business that stays open 24 hours per day, for instance, a convenience store, a hotel, or a motel, since the majority of robberies at such businesses occur during the nighttime. For these businesses, a trans-parent panel that can be closed within several seconds is provided. During the daytime when the risk of robberies is less, the panel can be left open to promote a friendly atmosphere. An example of a security window is operated electric motor causes upward-movement of the one moveable panel toward the roof of the module in order to close the module. However, due to the slow movement of motor, there is a possibility that the robbery shoot the gun to the clerk. It is the purpose of the current application to provide a more quickly responding safety shield that can protect the clerk and drive away the robberies by scaring them.

### DESCRIPTION OF THE PRIOR ART

U.S. Pat. No. 5,860,371 to Shelley illustrates a security window having one or more vertically movable panels, suitably of a transparent, rigid plastic that is bullet-resistant. The security window is useful for a clerk in a convenience store. The security window is provided with a safety mechanism that is operatively associated with the one or more vertically movable panels, and prevents direct vertical manual movement thereof by a would-be robber.

U.S. Pat. No. 4,034,685, to Word illustrates a bank teller's security closure having a vertically extending shield mounted relative to a teller's cage and adapted to be moved from an open, top position to a bottom, closed position so that access to the teller's cage, such as by a potential robber, is unobtainable. The moving shield may be constructed of bullet-proof glass, and is moved downwardly to the closed position by two cables, one disposed in each side channel of the cage. Each cable is wound around an upper and lower pulley. Besides an electrical activating means, the teller's shield has a manual activating means that is capable of operating upon failure of electrical power so that the shield may be lowered to the closed position, in the event of a power failure or the event of a robber disconnecting the power.

U.S. Pat. No. 1,777,760 to Murray, and U.S. Pat. No. 4,826,264 to Cass illustrate a security closure for a bank teller's cage. However, in contrast to the device in the patent to Word, the devices in these two patents involve multiple-panel, steel shutters that have lips on their edges for the purpose of interlinking and uniting them in a shingled relationship when the teller's cage is closed. In the patent to Murray, the steel panels move downwardly from an upper position to a lower position for the cage to be closed, whereas in the patent to Cass, the steel panels rise upwardly from a lower position to an upper position for the cage to be closed.

U.S. Pat. No. 2,908,051 to Sparkes, illustrates a window assembly having a plurality of window panels in shingled relationship, with the uppermost panel fixed at the top of the assembly. The remainder of the panels is vertically slidable. When the window is open, the panels are evenly stacked in superposed formation. As the slidable panels move from the open, top position, each succeeding movable panel is free to move downwardly from the top throughout its separate path independently of the immediately preceding panel to effect closure of the window. Moreover, like the steel panels in the above-mentioned patent to Murray and patent to Cass, the panels in the patent to Sparkes have lips on their edges so that the panels interlock by engaging respective edges as the panels move downwardly from the open, top position to the closed position. The panels are suitably manufactured from a lightweight plastic.

U.S. Pat. No. 2,320,604 to Jackson et al., which shows two or more telescoping door panels that, can be lowered from the ceiling to the floor vis-à-vis a plurality of pulleys secured equidistantly along a shaft, each pulley being provided with a lifting cable. The bottom ends of the lifting cables are attached to the top edges of the panel, and each cable has a pair of cylinders and pistons to equalize tension so that each panel can be operated evenly. The telescoping door panels are useful in aircraft hangers.

U.S. Pat. No. 1,193,908 to McCloud; U.S. Pat. No. 1,197,317 to Wexler; U.S. Pat. No. 1,258,297 to Arnold; U.S. Pat. No. 1,382,803 Robbins et al.; U.S. Pat. No. 1,623,674 to Hagestedt; U.S. Pat. No. 1,863,680 1932 to Young et al.; U.S. Pat. No. 2,984,194, to Jennings; and U.S. Pat. No. 3,067,700 to O'Meara et al. is also of some background interest vis-à-vis movable panels.

### SUMMARY OF THE INVENTION

There are many devices in the prior art for moving a door or window panel. In general, the prior devices relating to security cages for bank clerks have one moving panel that closes “instantaneously”, i.e., extremely quickly in about 0.5 second or less. The panel typically is an opaque steel shield. However, the need has been increasing for a security enclosure for night shift clerks in a business that stays open 24 hours per day, for instance, a convenience store, a hotel, or a motel, since the majority of robberies at such businesses occur during the nighttime. For these businesses, a trans-parent panel that can be closed within several seconds is provided. During the daytime when the risk of robberies is less, the panel can be left open to promote a friendly atmosphere. An example of a security window is operated electric motor causes upward-movement of the one moveable panel toward the roof of the module in order to close the module. However, due to the slow movement of motor, there is a possibility that the robbery shoot the gun to the clerk. It is the purpose of the current application to provide a more quickly responding safety shield that can protect the clerk and drive away the robberies by scaring them. The popping-up panel is suitably comprised of a light, transparent, and rigid plastic that is bullet-resistant. Purpose of the anti-rubbery shielding system according to current application is to protect a clerk in a convenience store, liquor shop, and other small stores which open until late night and to drive out a rubber by scaring. The anti-rubbery shielding system is provided with alert mechanisms of police car siren, voice message of a policeman, visual effect, video record that are operatively associated with the one or more vertically popping-up panels. The anti-rubbery shielding system is activated when the clerk press a button by foot.

### BRIEF DESCRIPTION OF THE DRAWINGS

FIG. 1 is a perspective drawing showing the situation of rubbery in a convenience store.

FIG. 2 is a cross-sectional view of a convenient store casher's desk in which an anti-rubbery shielding system according to current invention is installed.

FIG. 3 is an over view of the convenient store casher's desk in which an anti-rubbery shielding system according to current invention is installed, when the top board of the desk is removed.

FIG. 4 is a front view of the convenient store casher's desk in which an anti-rubbery shielding system according to current invention is installed, when the system is activated.

### DETAILED DESCRIPTION OF THE PREFERRED EMBODIMENT

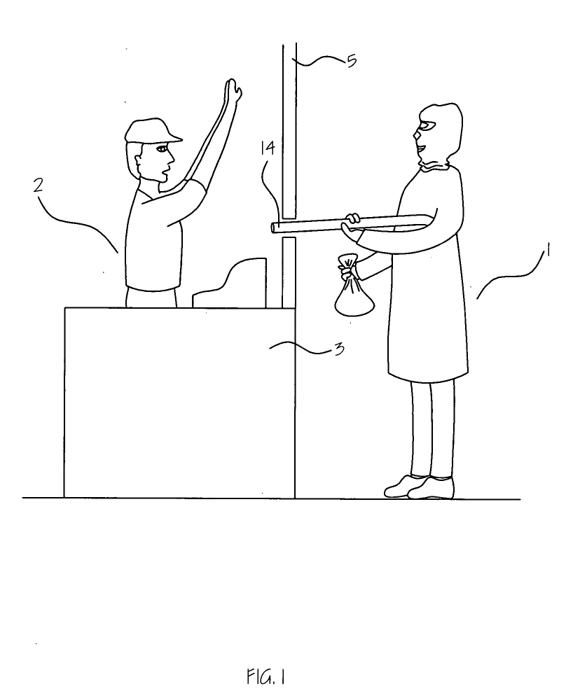

FIG. 1 is a perspective drawing showing the situation of rubbery in a convenience store. When a rubber (1) scares a clerk (2) in a convenience store at mid night, the first word the rubber say is “raise your hand” or “hands up”. This is to make sure that the clerk does not touch an emergency bell or a weapon. In this situation, the rubber can not see foot of the clerk.

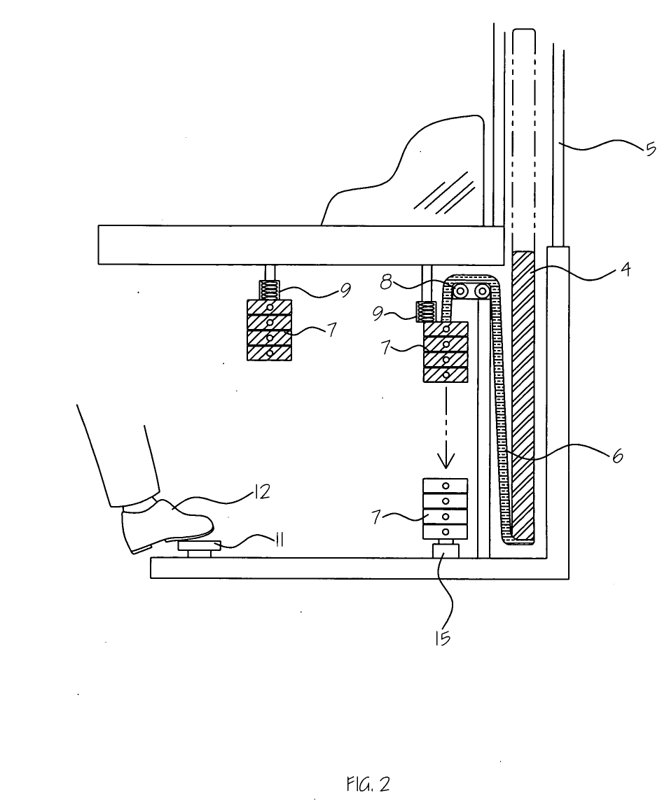

FIG. 2 is a cross-sectional view of a convenient store casher's desk (3) in which an anti-rubbery shielding system according to current invention is installed. The anti-rubbery shielding system is comprised of at least one light bullet-proof plastic sheet (4), at least one pair of guiding rail (5) for the plastic sheet (4), a rope (6) that is connecting one light bullet-proof plastic sheet (4) and a weights (7) that is comprised of pluralities of metal lumps, two wheeled pulley (8) that facilitate the movement of the system, and an electric magnet (9). When the light bullet-proof plastic sheet (4) is inserted in a groove (10), the weights (7) are held in an upper position by an electric magnet (9). When the clerk (2) pushes a button (11) with a foot (12), the electricity is cut and the electric magnet (9) loose magneticity. Then, the weights (7) fall freely. Weight of the weights (7) is adjusted and usually over 5 times that of the light bullet-proof sheet (5) plus the rope (6). The guiding rail (5) supports the plastic sheet (4) when the plate (4) comes out of the groove (10) and stands over the desk (3). Electric wires for the electric magnet (9) are installed in the guiding rail (5). An emergency electricity from a battery is connected to the electric magnet (9) to hold the weights (7) in position.

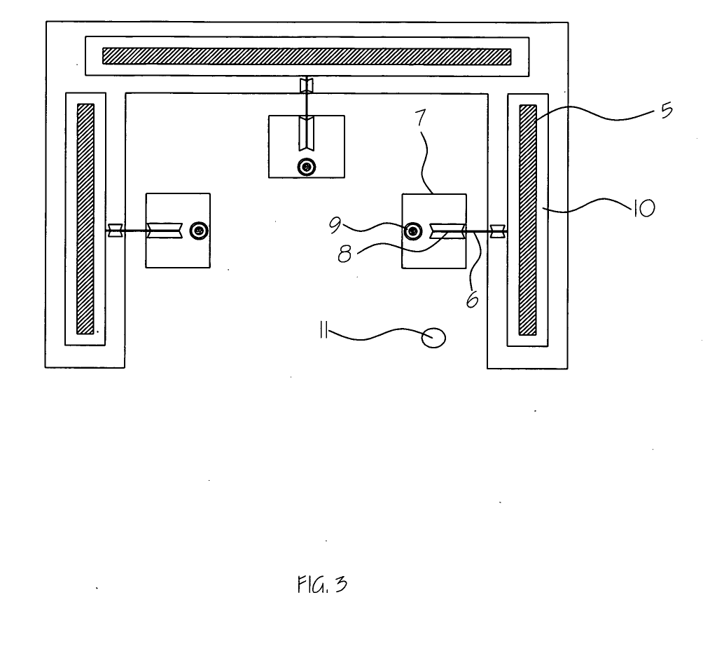

FIG. 3 is an over view of the convenient store casher's desk (3) in which an anti-rubbery shielding system according to current invention is installed, when the top board of the desk is removed. The anti-rubbery shielding system has three faces to protect the clerk (2). Number of faces is optionally selected by the owner of the store.

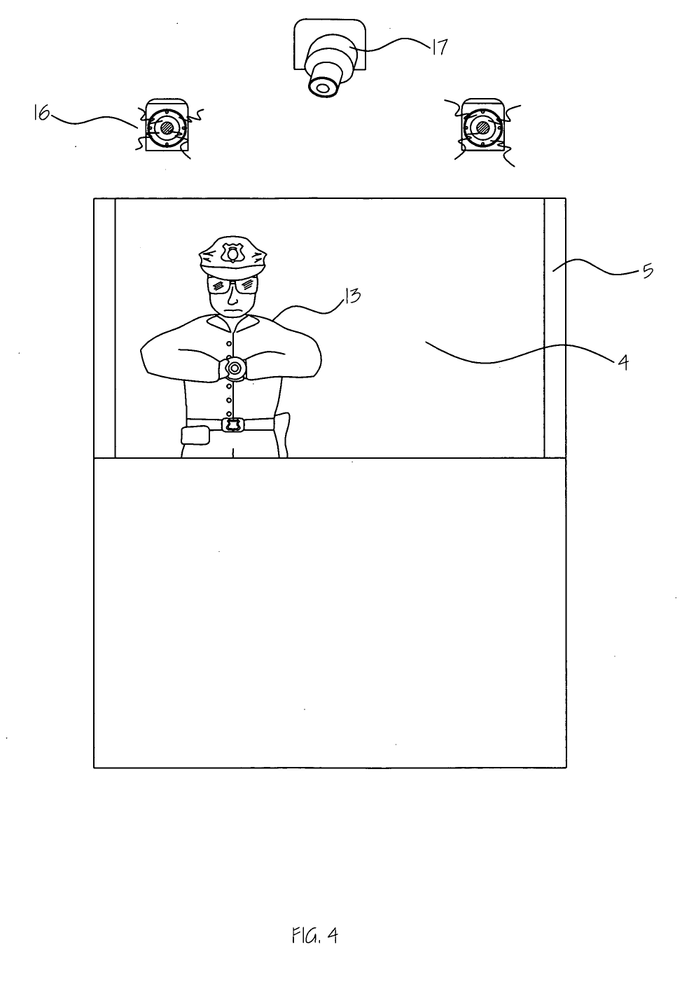

FIG. 4 is a front view of the convenient store casher's desk in which an anti-rubbery shielding system according to current invention is installed, when the system is activated. As the weights (7) fall down, the light bullet-proof plastic sheet (5) pops-up. A photography of policeman (13) wearing a regular uniform and pointing a pistol is drawn on the sheet in three dimensional drawing. At this moment the rubbery (1) is frightened and the sheet (4) hit a weapon, usually a gun (14), of the rubbery upward. Though the rubbery shot the gun (14) by accident, the bullet from the gun can not hit the clerk (2). The clerk (2) instantly hides under the desk (3).

As the weight (7) falls down and activates another electric button (15), it activates the speaker to play the recorded sound alarm of “Freeze, police. Drop your weapon” and siren of a police car is shouted through speakers (16) and activates the CCTV camera (17) to take a picture of the rubbery (2) in front of the clerk's desk.

Then there is no way of the rubbery but to run away.

What is claimed is:

1. An anti-rubbery shielding system installed in groove of a clerk's desk of a convenience store is comprised of:
one light bullet-proof plastic sheet on which a photography of policeman wearing a regular uniform and pointing a pistol is drawn on the sheet in three dimensional drawing, and
one pair of guiding rail to hold the plastic sheet when the plate comes out of the groove and stands over a desk, and
a weights that is comprised of pluralities of small metal lumps, and
one rope that is connecting the light bullet-proof plastic sheet and weights, and
two wheeled pulley that facilitate the movement of the system, and
an electric magnet that holds the weights in an upper position, and
one electric button that cuts electricity from the electric magnet when the clerk pushes the button with a foot, and
a speaker through which a recorded sound alarm of “Freeze, police. Drop your weapon” and siren of a police car is shouted, and
a CCTV camera that takes a picture of a rubbery in front of the clerk's desk, and
another electric button that is hit by the falling weights and activates the speaker to play the recorded sound alarm and activates the CCTV to take a still picture of the rubbery, and
an emergency electricity from a battery is connected to the electric magnet to hold the weights in position.

2. An anti-rubbery shielding system installed in groove of a clerk's desk of a convenience store of claim 1, wherein weight of the weights are adjusted and over 5 times that of the light bullet-proof sheet plus the rope.

3. An anti-rubbery shielding system installed in groove of a clerk's desk of a convenience store of claim 1, wherein the anti-rubbery shielding system has three faces to protect the clerk.
